(19) United States
(12) Patent Application Publication
(10) Pub. No.: US 2022/0261692 A1
(43) Pub. Date: Aug. 18, 2022

(54) SYSTEM AND METHOD FOR ECONOMIC VIRTUOUS CYCLE SIMULATION BASED ON ARTIFICIAL INTELLIGENCE TWIN

(71) Applicant: Electronics and Telecommunications Research Institute, Daejeon (KR)

(72) Inventors: Yeon Hee LEE, Daejeon (KR); Hyun Joong KANG, Daejeon (KR); Yeong Min KIM, Daejeon (KR); Tae Hwan KIM, Daejeon (KR); Hyeon Jae KIM, Daejeon (KR); Tae Wan YOU, Daejeon (KR); Wan Seon LIM, Daejeon (KR); Hoo Young AHN, Daejeon (KR); Do Yeob YEO, Daejeon (KR); Ho Sung LEE, Daejeon (KR)

(73) Assignee: Electronics and Telecommunications Research Institute, Daejeon (KR)

(21) Appl. No.: 17/673,431

(22) Filed: Feb. 16, 2022

(30) Foreign Application Priority Data
Feb. 16, 2021 (KR) 10-2021-0020721
Dec. 28, 2021 (KR) 10-2021-0190050

(51) Int. Cl. G06N 20/00

(52) U.S. Cl. CPC G06N 20/00

(57) ABSTRACT

Provided is a system and method for economic virtuous cycle simulation based on an artificial intelligence (AI) twin. The system for economic virtuous cycle simulation based on an AI twin includes an AI twin initial training unit configured to perform initial training on an AI twin model and learn initial parameters using an economic model, an AI twin optimization training unit configured to perform optimization tuning on the initial parameters of the AI twin model using past data collected in an initially trained model, an AI twin generating unit configured to generate an AI twin based on a learning model, and an AI twin operation unit configured to acquire an index for economic prediction to update the AI twin and perform an AI twin-based simulation.

### CROSS-REFERENCE TO RELATED APPLICATION

This application claims priority to and the benefit of Korean Patent Applications Nos. 10-2021-0020721, filed on Feb. 16, 2021, and 10-2021-0190050, filed on Dec. 28, 2021, the disclosures of which are incorporated herein by reference in its entirety.

### BACKGROUND

### 1. Field of the Invention

The present invention relates to a system and method for economic virtuous cycle simulation based on an artificial intelligence (AI) twin.

### 2. Discussion of Related Art

In the conventional economic prediction method using a macroeconomic model, human errors are highly likely to occur in relation to the composition and parameters of a behavioral equation, a judgment or prediction result is highly likely to be different from reality, and there is a need for consistent observation and efforts by experts to reflect changes in the economy or conditions in a model.

### SUMMARY OF THE INVENTION

The present invention has been proposed to solve the above-described problem and is directed to a system and method for economic virtuous cycle simulation based on a data-driven artificial intelligence (AI) twin, that are capable of simulating an economic virtuous cycle in which a budget investment causes economic and social effects, and the effects lead to an increase or decrease of income, thus enabling economic prediction and diagnosis.

The technical objectives of the present invention are not limited to the above, and other objectives may become apparent to those of ordinary skill in the art based on the following description.

According to an aspect of the present invention, there is provided a system for economic virtuous cycle simulation based on an AI twin, the system including: an AI twin initial training unit configured to perform initial training on an AI twin model and learn initial parameters using an economic model; an AI twin optimization training unit configured to perform optimization tuning on the initial parameters of the AI twin model using past data collected in an initially trained model; an AI twin generating unit configured to generate an AI twin based on a learning model; and an AI twin operation unit configured to acquire an index for economic prediction to update the AI twin and perform an AI twin-based simulation.

The AI twin initial training unit may include: a training feature data input unit configured to generate feature data to be used as an input of the economic model; an initial training execution unit configured to train the AI twin and calculate the initial parameters using training data as an input; and an AI twin acquisition unit configured to acquire an initially trained AI twin.

The system may further include an economic model optimization and update unit configured to adjust a variable of an existing economic model according to a use index of the AI twin and update the economic model.

The AI twin operation unit may include: an index acquisition unit configured to acquire index data; an AI twin model update unit configured to, according to determination of whether to optimize the AI twin model, perform training to optimize the AI twin model, and update the AI twin model; an AI twin simulation integrated analysis unit configured to perform a simulation based on the AI twin to perform judgment or prediction; and a decision value extraction and application unit configured to extract a decision value using an analysis result and apply the extracted decision value to a real environment.

According to another aspect of the present invention, there is provided a method for economic virtuous cycle simulation based on an artificial intelligence (AI) twin, the method including the steps of: (a) training an AI twin for simulation using an economic model; (b) operating the AI twin for simulation on which the training is completed; and (c) determining whether initialization is required for the trained AI twin according to performance of the AI twin, wherein the step (a) and the step (b) are iteratively performed based on a result of the determining in the step (c).

The step (a) may include the steps of: (a-1) learning initial parameters using the economic model; (a-2) performing tuning on the initial parameters using past collection data; and (a-3) generating an AI twin based on a learning model.

The step (a-1) may include the steps of: (a-1-1) generating feature data to be used as an input of the economic model, and performing prediction and judgment using the feature data to output a result of the prediction and judgment; (a-1-2) assembling the result output in the step (a-1-1) with a label value of the feature data to generate training data; and (a-1-3) performing AI twin training using the training data and calculating the initial parameters to acquire an initially trained AI twin.

The step (b) may include the steps of: (b-1) acquiring real index data for economic prediction and determining whether to optimize an AI twin model; (b-2) according to determination to optimize the AI twin model, performing training to optimize the AI twin model and updating the AI twin model; (b-3) after completion of the update or according to determination not to proceed with optimization, performing an AI twin-based simulation to perform a judgment or prediction, extracting a decision value using a result of the judgment or prediction, and applying the decision value to a real environment; and (b-4) acquiring index data updated according to the application to the real environment and performing the step (b-1) and the subsequent steps.

According to another aspect of the present invention, there is provided a system for economic virtuous cycle simulation based on an artificial intelligence (AI) twin, the system including: an input unit configured to receive an economic model; a memory in which a program for performing an AI twin-based economic virtuous cycle simulation using the economic model is stored; and a processor configured to execute the program, wherein the processor is configured to perform initial training on an AI twin model using the economic model, generate an AI twin, and iterate a process of updating the AI twin and performing an AI twin-based simulation.

The input unit may be configured to receive at least one of a macroeconomic model, an econometric model, and an AI-based economic model as the economic model.

The processor may be configured to acquire a prediction result of economy through the iterative execution in a preset period.

The processor may be configured to generate feature data to be used as an input of the economic model, train the AI twin and calculate initial parameters using the feature data, and acquire an initially trained AI twin.

The processor may be configured to adjust variables of the economic model according to a use index of the AI twin and update the economic model.

The processor may be configured to extract a decision value using a result of performing a simulation based on the AI twin, apply the decision value to a real environment, and acquire an index change according to the real environment to perform optimization on the AI twin.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 illustrates a method for economic virtuous cycle simulation based on an artificial intelligence (AI) twin according to an embodiment of the present invention;

FIG. 2 illustrates a learning process of a method for economic virtuous cycle simulation based on an AI twin according to an embodiment of the present invention;

FIG. 3 illustrates an AI twin initial training process of a method for economic virtuous cycle simulation based on an AI twin according to an embodiment of the present invention;

FIG. 4 illustrates an AI twin operation process of a method for economic virtuous cycle simulation based on an AI twin according to an embodiment of the present invention;

FIG. 5 illustrates a block diagram of a system for economic virtuous cycle simulation based on an AI twin according to an embodiment of the present invention;

FIG. 6 illustrates a system for economic virtuous cycle simulation based on an AI twin according to an embodiment of the present invention;

FIG. 7 illustrates a detailed structure of an AI twin initial training unit according to an embodiment of the present invention;

FIG. 8 illustrates a detailed structure of an AI twin operation unit according to an embodiment of the present invention; and

FIG. 9 illustrates a block diagram of a system for economic virtuous cycle simulation based on an AI twin according to an embodiment of the present invention.

### DETAILED DESCRIPTION OF EXEMPLARY EMBODIMENTS

Hereinafter, the above and other objectives, advantages, and features of the present invention and ways of achieving them will become readily apparent with reference to descriptions of the following detailed embodiments in conjunction with the accompanying drawings

However, the present invention is not limited to embodiments to be described below and may be embodied in various forms. The embodiments to be described below are provided only to assist those skilled in the art in fully understanding the objectives, configurations, and effects of the invention, and the scope of the present invention is defined only by the appended claims.

Meanwhile, terms used herein are used to aid in the explanation and understanding of the embodiments and are not intended to limit the scope and spirit of the present invention. It should be understood that the singular forms “a” and “an” also include the plural forms unless the context clearly dictates otherwise. The terms “comprises,” “comprising,” “includes,” and/or “including,” when used herein, specify the presence of stated features, integers, steps, operations, elements, components and/or groups thereof and do not preclude the presence or addition of one or more other features, integers, steps, operations, elements, components, and/or groups thereof.

Before describing the embodiments of the present invention, the background for proposing the present invention will be described first for the sake of understanding for those skilled in the art.

The economic prediction method using a macroeconomic model according to the related art is mainly characterized by constructing a behavioral equation as shown in [Equation 1].

Log(Gross Domestic Product)=α×Log (Real Economic Index #1)+γ×Log (Real Economic Index #1#2)++δ×Log (Real Economic Index #1#n−1)+ζ×Log (Real Economic Index #1#n)+θ×Dummy Variable+ε [Equation 1]

The behavioral equation-based economic model according to the related art has limitations in that i) because the composition and parameters of a behavioral equation are determined by an expert, such as an economist, various human errors are highly likely to occur depending on the experience and ability of the expert, ii) because the model is defined by an expert's hypothesis, a judgment or prediction result is greatly different from reality, and iii) there is a need for continuous observation and efforts by experts to reflect changes in the economy or conditions in the model.

On the other hand, in an artificial intelligence (AI)-based method, which is a method of estimating a behavioral equation by data-based learning, phenomena that have been experienced in the past may be learned, but the accuracy of judgment and prediction on phenomena that have never been experienced may not be ensured.

The present invention has been proposed to solve the above limitations, and proposes a system and method for economic virtuous cycle simulation based on a digital driven AI twin that enables economic prediction and diagnosis by simulating a virtuous cycle of the economy in which a budget investment causes economic and social effects, and the effects thereby lead to an increase or decrease of income.

An AI twin is defined as a digital twin in which behavioral properties of objects in reality are defined using AI algorithms and relates to a technology of generating a twin of an object in the real world on a computer and simulating a situation that may occur in the real world using the computer.

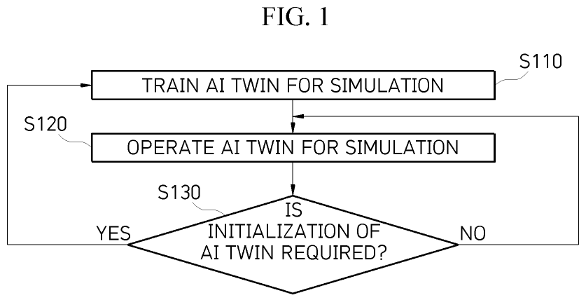

FIG. 1 illustrates a method for economic virtuous cycle simulation based on an AI twin according to an embodiment of the present invention.

The method for economic virtuous cycle simulation based on an AI twin according to the embodiment of the present invention includes training an AI twin for simulation to perform analysis through economic/social simulation (S110), operating the AI twin for simulation on which the training is completed (S120), and determining whether to initialize the trained twin model according to the performance of the AI twin (S130).

Upon determination in operation 5130 that initialization is to be performed, the AI twin for simulation is newly trained in operation S110, and upon determination in operation S130 that initialization is not required, the operation S120 of operating the AI twin without training is performed continuously.

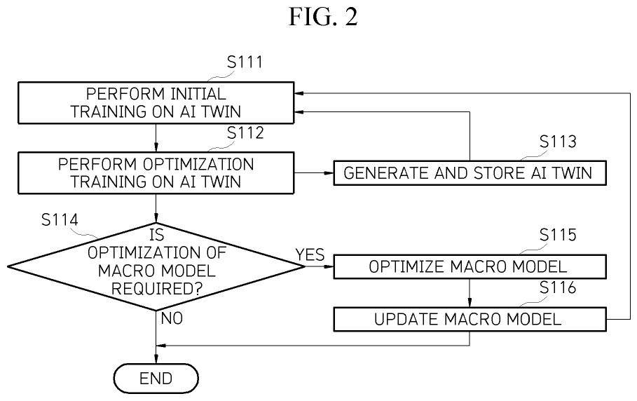

FIG. 2 illustrates a learning process of a method for economic virtuous cycle simulation based on an AI twin according to an embodiment of the present invention.

In operation S111, AI twin model initial training is performed using a macro model written by existing experts, to learn initial parameters.

In operation S112, optimization tuning is performed on the initially learned parameters of the Al twin model using past data collected in an initially trained model.

In operation S113, an AI twin is generated based on a learning model, and is stored.

In operation S114, it is determined whether optimization of the macro model is required.

Upon determination in operation S114 that the macro-model optimization is required, variables of the existing macro-model are adjusted according to a use index of the generated AI twin to optimize the macro model (upon determination in operation S114 that macro-model optimization is not required, the corresponding learning process is terminated) in operation S115.

In operation S116, the macro model according to the optimization is updated.

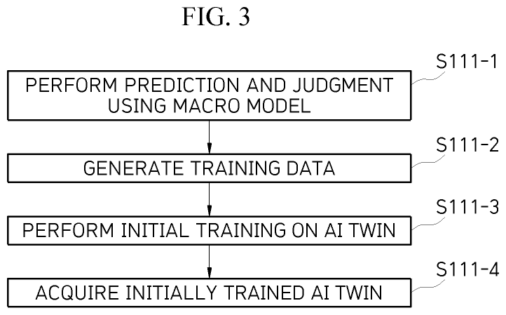

FIG. 3 illustrates an AI twin initial training process of a method for economic virtuous cycle simulation based on an AI twin according to an embodiment of the present invention.

In operation S111-1, feature data to be used as an input of the macro model is randomly generated, and the generated data is input as an input of the macro model to perform prediction and judgment according to the model and output a result thereof.

In operation S111-2, the result (result data of prediction or judgment) output in the operation S111-1 is assembled with a label value of the randomly generated feature data to generate training data.

In operation S111-3, the AI twin is trained using the training data generated in operation S111-2 as an input, and initial parameters are calculated to thereby acquire an initially trained Al twin in operation S111-4.

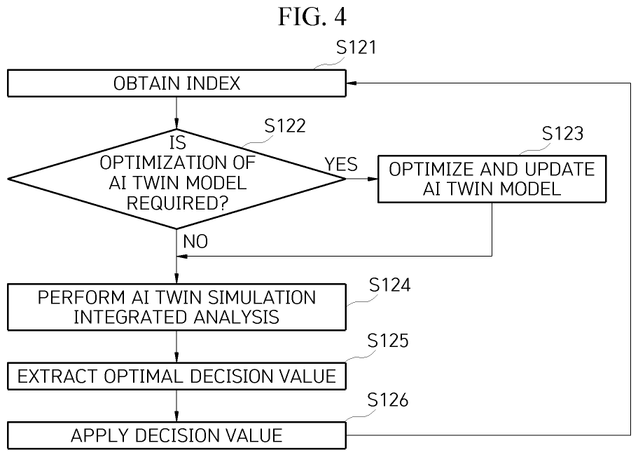

FIG. 4 illustrates an AI twin operation process of a method for economic virtuous cycle simulation based on an AI twin according to an embodiment of the present invention.

In operation S121, various pieces of real index data for economic prediction are obtained.

In operation S122, whether to optimize an AI twin model is determined.

Upon determination in operation S122 that optimization of the AI twin model is required, training to optimize the AI twin model is performed and the AI twin model is updated in operation S123.

Upon determination in operation S122 that optimization of the AI twin model is not required, AI twin-based simulation is performed to perform a judgment or prediction in operation S124.

In operation S125, an optimal decision value (a corresponding value) is extracted using an integrated analysis result output in operation S124.

In operation S126, the optimal decision value extracted in operation S125 is applied to a real environment, through which an index newly updated according to the application is acquired in operation 121 so that the process of optimizing the AI twin is iterated.

In the AI twin operation process shown in FIG. 4, a process of continuously acquiring an index to optimize the AI twin model as needed, performing simulation analysis using the optimized AI twin model, and performing a decision is iteratively performed.

With the iterative execution of the virtuous cycle structure according to the embodiment of the present invention, short-term or long-term prediction results of the economy are acquired, and a virtuous cycle of the above-described operations is made daily, monthly, yearly, or in a period designated as needed, in order to repeatedly perform predictions.

In optimizing the existing economic model using the obtained index according to the embodiment of the present invention, the economic model may be an existing macroeconomic model, an econometric model, or an AI-based economic model, or may be a federated model combining an AI-based economic model, a macroeconomic model, and an econometric model, that may be adaptively optimized in conjunction.

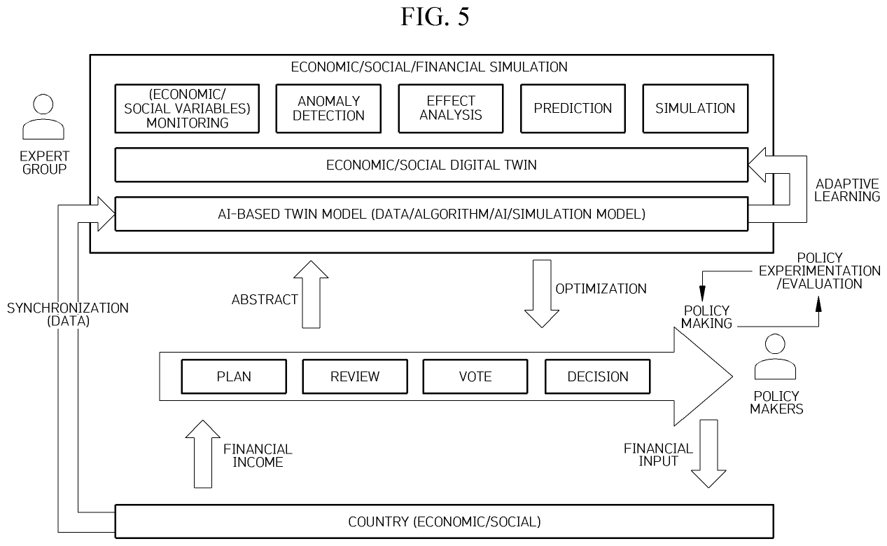

FIG. 5 illustrates a block diagram of a system for economic virtuous cycle simulation based on an AI twin according to an embodiment of the present invention.

The system for economic virtuous cycle simulation based on an AI twin according to the embodiment of the present invention may include AI-based twin models, an economic/social complex digital twin that represents economic or social phenomena by gathering of twin models, and twin applications, such as digital twin-based monitoring, anomaly detection, effect analysis, prediction, and simulation.

The AI-based twin model performs adaptive learning using data in association with the existing macro models or alone, and has a combination of data, algorithms, and AI models/simulation models.

A policy maker is a user of the system for economic virtuous cycle simulation based on an AI twin, and conducts experiments and evaluations for important policy decisions, such as fiscal input, through simulation of the system for economic virtuous cycle simulation based on an AI twin.

When the optimal policy is determined as a result of the policy decision or simulation, the result is applied to an actual environment (a country), changes in various economic/social indexes as a result of the application are collected and projected on the AI twin, and monitoring and prediction simulations are performed in a series of iterative executions.

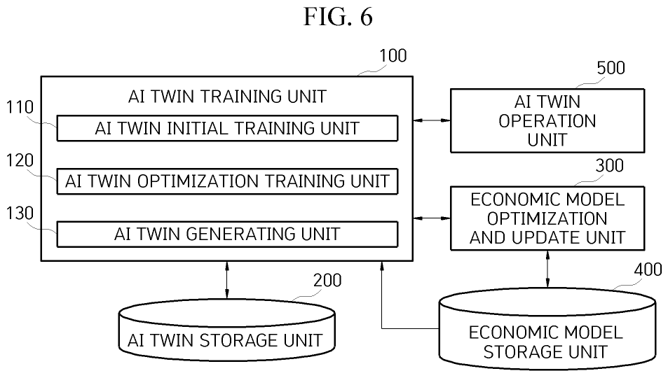

FIG. 6 illustrates a system for economic virtuous cycle simulation based on an AI twin according to an embodiment of the present invention.

The system for economic virtuous cycle simulation based on an AI twin includes an AI twin training unit 100, an economic model optimization and update unit 300, and an AI twin operation unit 500.

The AI twin training unit 100 includes an AI twin initial training unit 110, an AI twin optimization training unit 120, and an AI twin generating unit 130.

The AI twin initial training unit 110 performs initial training on an AI twin model using a macro model, and learns initial parameters.

The AI twin optimization training unit 120 performs optimization tuning on the initially learned parameters of the AI twin model using past data collected in an initially trained model.

The AI twin generating unit 130 generates an AI twin on the basis of a learning model, and an AI twin storage unit 200 stores the generated AI twin.

The economic model optimization and update unit 300 adjusts and optimizes variables of the existing macro model according to a use index of the AI twin, updates the macro model according to the optimization, and stores the updated macro model in an economic model storage unit 400.

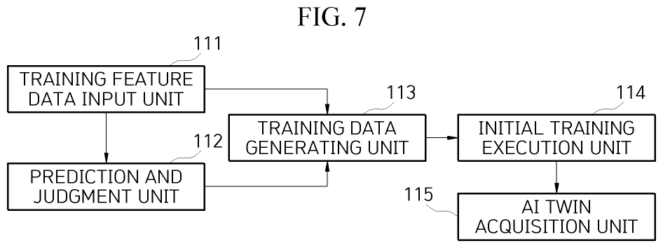

FIG. 7 illustrates a detailed structure of an AI twin initial training unit according to an embodiment of the present invention.

A training feature data input unit 111 generates feature data to be used as an input of the macro model and inputs the feature data as an input of the macro model.

A prediction and judgment unit 112 performs prediction and judgment according to the macro model and outputs a result of the prediction and judgment.

A training data generating unit 113 generates training data by assembling the result of the prediction and judgment with a label value of the randomly generated feature data.

An initial training execution unit 114 trains the AI twin using the training data as an input and calculates initial parameters, and an AI twin acquisition unit 115 acquires an initially trained AI twin.

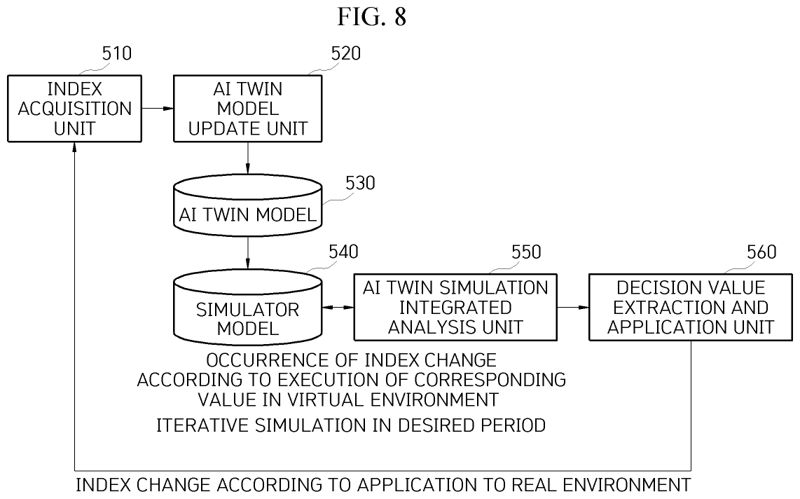

FIG. 8 illustrates a detailed structure of an AI twin operation unit according to an embodiment of the present invention.

An index acquisition unit 510 acquires various types of real index data for economic prediction.

An AI twin model update unit 520 performs training to optimize an AI twin model according to determination of whether to optimize the AI twin model and updates the AI twin model.

Accordingly, an AI twin model 530 and an AI twin-based simulator model 540 are stored.

An AI twin simulation integrated analysis unit 550 performs judgment or prediction by performing AI twin-based simulation.

A decision value extraction and application unit 560 extracts an optimal decision value (a corresponding value) using a result of integrated analysis, and applies the extracted optimal decision value to a real environment.

An index (a change in the index) newly updated as a result of applying the optimal decision value to the real environment is acquired, and the AI twin optimization process is repeatedly performed.

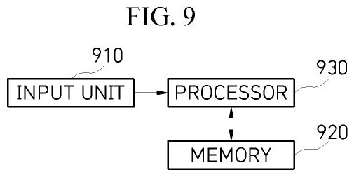

FIG. 9 illustrates a block diagram of a system for economic virtuous cycle simulation based on an AI twin according to an embodiment of the present invention.

The system for economic virtuous cycle simulation based on an AI twin according to the embodiment of the present invention includes an input unit 910 configured to receive an economic model, a memory 920 in which a program for performing an AI twin-based economic virtuous cycle simulation using the economic model is stored, and a processor 930 configured to execute the program, and the processor 930 performs AI twin model initial training using the economic model, generates an AI twin, and iterates a process of updating the AI twin and performing an AI twin-based simulation.

The input unit 910 receives at least one of a macroeconomic model, an econometric model, and an AI-based economic model as the economic model.

The processor 930 acquires a result of economic prediction through the iterative execution in a preset period.

The processor 930 generates feature data to be used as an input of the economic model, trains the AI twin and calculates initial parameters using the feature data, and acquires an initially trained AI twin.

The processor 930 adjusts variables of the economic model according to a use index of the AI twin, and updates the economic model.

The processor 930 extracts a decision value using a result of performing an AI twin-based simulation, applies the decision value to a real environment, and acquires an index change according to the real environment to perform optimization on the AI twin.

Meanwhile, the method for economic virtuous cycle simulation based on an AI twin according to the embodiment of the present invention may be implemented in a computer system or may be recorded on a recording medium. The computer system may include at least one processor, a memory, a user input device, a data communication bus, a user output device, and a storage. The above-described components perform data communication through the data communication bus.

The computer system may further include a network interface coupled to a network. The processor may be a central processing unit (CPU) or a semiconductor device for processing instructions stored in the memory and/or storage.

The memory and the storage may include various forms of volatile or nonvolatile media. For example, the memory may include a read only memory (ROM) or a random-access memory (RAM).

Accordingly, the method for economic virtuous cycle simulation based on an AI twin according to the embodiment of the present invention may be implemented in a computer-executable form. When the method for economic virtuous cycle simulation based on an AI twin according to the embodiment of the present invention is performed by the computer, the method for economic virtuous cycle simulation based on an AI twin according to the embodiment of the present invention may be performed according to instructions readable by the computer.

Meanwhile, the method for economic virtuous cycle simulation based on an AI twin according to the embodiment of the present invention may be embodied as computer readable code on a computer-readable recording medium. The computer-readable recording medium is any recording medium that can store data that can be read by a computer system. Examples of the computer-readable recording medium include a ROM, a RAM, a magnetic tape, a magnetic disk, a flash memory, an optical data storage, and the like. In addition, the computer-readable recording medium may be distributed over network-connected computer systems so that computer readable code may be stored and executed in a distributed manner.

As is apparent from the above, according to the present invention, a data-driven virtuous cycle structure is provided so that an algorithm capable of identifying patterns from data along with generation of the data and predicting the future through the identification of the patterns can be automatically learned, and an optimal model can be obtained by itself. With such a configuration, the existing cumbersomeness and human error accompanied by the model development and management based on the experience of the experts can be eliminated.

According to the present invention, a data-driven complementary structure of an AI learning based model and the existing behavioral-based macroeconomic model is provided so that the system can compensate for the shortcomings of each method in the structure and judge and predict a phenomenon that has not been experienced in the past.

The effects of the present invention are not limited to those described above, and other effects not described above will be clearly understood by those skilled in the art from the above detailed description.

What is claimed is:

1. A system for economic virtuous cycle simulation based on an artificial intelligence (AI) twin, the system comprising:
an AI twin initial training unit configured to perform initial training on an AI twin model and learn initial parameters using an economic model;
an AI twin optimization training unit configured to perform optimization tuning on the initial parameters of the AI twin model using past data collected in an initially trained model;
an AI twin generating unit configured to generate an AI twin based on a learning model; and
an AI twin operation unit configured to acquire an index for economic prediction to update the AI twin and perform an AI twin-based simulation.

2. The system of claim 1, wherein the AI twin initial training unit includes:
a training feature data input unit configured to generate feature data to be used as an input of the economic model;
an initial training execution unit configured to train the AI twin and calculate the initial parameters using training data as an input; and
an AI twin acquisition unit configured to acquire an initially trained AI twin.

3. The system of claim 1, further comprising an economic model optimization and update unit configured to adjust a variable of an existing economic model according to a use index of the AI twin and update the economic model.

4. The system of claim 1, wherein the AI twin operation unit includes:
an index acquisition unit configured to acquire index data;
an AI twin model update unit configured to, according to determination of whether to optimize the AI twin model, perform training to optimize the AI twin model, and update the AI twin model;
an AI twin simulation integrated analysis unit configured to perform a simulation based on the AI twin to perform judgment or prediction; and
a decision value extraction and application unit configured to extract a decision value using an analysis result and apply the extracted decision value to a real environment.

5. A method for economic virtuous cycle simulation based on an artificial intelligence (AI) twin, the method comprising the steps of:
(a) training an AI twin for simulation using an economic model;
(b) operating the AI twin for simulation on which the training is completed; and
(c) determining whether initialization is required for the trained AI twin according to performance of the AI twin,
wherein the step (a) and the step (b) are iteratively performed based on a result of the determining in the step (c).

6. The method of claim 5, wherein the step (a) includes the steps of:
(a-1) learning initial parameters using the economic model;
(a-2) performing tuning on the initial parameters using past collection data; and
(a-3) generating an AI twin based on a learning model.

7. The method of claim 6, wherein the step (a-1) includes the steps of:
(a-1-1) generating feature data to be used as an input of the economic model, and performing prediction and judgment using the feature data to output a result of the prediction and judgment;
(a-1-2) assembling the result output in the step (a-1-1) with a label value of the feature data to generate training data; and
(a-1-3) performing AI twin training using the training data and calculating the initial parameters to acquire an initially trained AI twin.

8. The method of claim 5, wherein the step (b) includes the steps of:
(b-1) acquiring real index data for economic prediction and determining whether to optimize an AI twin model;
(b-2) according to determination to optimize the AI twin model, performing training to optimize the AI twin model and updating the AI twin model;
(b-3) after completion of the update or according to determination not to proceed with optimization, performing an AI twin-based simulation to perform a judgment or prediction, extracting a decision value using a result of the judgment or prediction, and applying the decision value to a real environment; and
(b-4) acquiring index data updated according to the application to the real environment and performing the step (b-1) and the subsequent steps.

9. A system for economic virtuous cycle simulation based on an artificial intelligence (AI) twin, the system comprising:
an input unit configured to receive an economic model;
a memory in which a program for performing an AI twin-based economic virtuous cycle simulation using the economic model is stored; and
a processor configured to execute the program,
wherein the processor is configured to perform initial training on an AI twin model using the economic model, generate an AI twin, and iterate a process of updating the AI twin and performing an AI twin-based simulation.

10. The system of claim 9, wherein the input unit is configured to receive at least one of a macroeconomic model, an econometric model, and an AI-based economic model as the economic model.

11. The system of claim 9, wherein the processor is configured to acquire a prediction result of economy through the iterative execution in a preset period.

12. The system of claim 9, wherein the processor is configured to generate feature data to be used as an input of the economic model, train the AI twin and calculate initial parameters using the feature data, and acquire an initially trained AI twin.

13. The system of claim 9, wherein the processor is configured to adjust variables of the economic model according to a use index of the AI twin and update the economic model.

14. The system of claim 9, wherein the processor is configured to extract a decision value using a result of performing a simulation based on the AI twin, apply the decision value to a real environment, and acquire an index change according to the real environment to perform optimization on the AI twin.

15. A method for training an AI twin for simulation using an economic model, the method comprising the steps of:
(a) generating feature data to be used as an input of the economic model, and performing prediction and judgment using the feature data to output a result of the prediction and judgment;
(b) assembling the result output in the step (a) with a label value of the feature data to generate training data; and
(c) performing AI twin training using the training data and calculating the initial parameters to acquire an initially trained AI twin.
